(19) United States
(12) Patent Application Publication
(10) Pub. No.: US 2019/0353255 A1
(43) Pub. Date: Nov. 21, 2019

(54) VALVE COMBINATION

(71) Applicant: EVOGUARD GmbH, Nittenau (DE)

(72) Inventors: Johann JUSTL, Sinzing (DE); Martin SAUER, Kaisheim (DE)

(21) Appl. No.: 16/412,136

(22) Filed: May 14, 2019

(30) Foreign Application Priority Data
May 15, 2018 (DE) 10 2018 207 522.0

(51) Int. Cl. F16K 1/44; B08B 9/093

(52) U.S. Cl. CPC F16K 1/446; B08B 9/093

(57) ABSTRACT

A valve combination is for connecting a first fluid chamber boundary to a second fluid chamber boundary via a safety chamber. The valve combination includes a first valve having a first valve seat and a first closure member and a second valve having a second valve seat and a second closure member. The first valve is configured to seal the first fluid chamber boundary against the safety chamber and the second valve is configured to seal the second fluid chamber boundary against the safety chamber. The valve combination is configured to provide, via the first valve seat and the second valve seat, thermal insulation of the safety chamber against the first fluid chamber boundary and the second fluid chamber boundary.

### RELATED APPLICATION

This application claims the benefit under 35 U.S.C § 119(a) of German Application No. 10 2018 207 522.0, filed May 15, 2018, which is incorporated by reference.

### TECHNICAL FIELD

The present disclosure relates to a valve combination for connecting two fluid chamber boundaries.

### BACKGROUND

Conventional systems may include valve combinations for connecting tubes. One example of such a valve combination, which in the case described is included in a double-seat and/or double-seal valve, is described in EP 2 592 312. Such valve combinations are used in the food processing sector e.g. in the aseptic sector. Provided between the valve housings or tubes, respectively, is a safety chamber (also referred to as leakage chamber) via which the tubes can be connected by the valves. This safety chamber can be cleaned and disinfected, in particular sterilized, independently of the two valve housings or tubes, respectively, for example, using steam.

For some applications, it is desirable to have this safety chamber be continuously subjected to steam, so that no bacteria can accumulate in the safety chamber. However, the wall of the safety chamber is typically made of metal because this material is easy to clean and disinfect. But this can result in heat spreading through the walls of the safety chamber and caking the products in the valve housings or tubes (in particular, for example, in the seat region of a valve). These deposits can detach and contaminate the product. In addition, such caking can make cleaning difficult and require disassembly of the valve combination and the tubes for manual cleaning.

### BRIEF DESCRIPTION OF THE DRAWINGS

Embodiments of the present disclosure are illustrated by way of example, and not by way of limitation, in the figures of the accompanying drawings.

FIG. 1a shows a cross section of a valve combination, according to certain embodiments.

FIG. 1b shows details of FIG. 1a, according to certain embodiments.

FIG. 1c shows details of FIG. 1a, according to certain embodiments.

FIG. 2a shows a cross section of a valve combination, according to certain embodiments.

FIG. 2b shows details of FIG. 2a, according to certain embodiments.

FIG. 2c shows details of FIG. 2a, according to certain embodiments.

FIG. 3a shows a cross section of a valve combination, according to certain embodiments.

FIG. 3b shows details of FIG. 3a, according to certain embodiments.

### DETAILED DESCRIPTION

The present disclosure provides an improved valve combination.

The present disclosure includes a valve combination, a double-seat and/or double-seal valve, a machine for filling containers, as well as a device in the food and beverage treatment sector.

According to the present disclosure, the valve combination for connecting a first fluid chamber boundary to a second fluid chamber boundary via a safety chamber includes a first valve having a first valve seat and a first closure member and a second valve having a second valve seat and a second closure member. The closure members can be formed, for example, as a disk, a cone, a ball or a pin. In some embodiments, disks are used as the closure members for the first and the second valve, where the first and the second valve can be disk valves. The respective valve disks (or other closure members) may be sealed against the valve seat by a sealing ring or other sealing device when the valve is closed.

Advantageously, the first valve and the second valve can be actuatable independently of each other.

A fluid chamber boundary can include a tube or a tube section. In some embodiments, the fluid chamber boundary includes or is formed as a (valve) housing on or in which the first or the second valve can be arranged. In some embodiments, a fluid chamber boundary can include, for example, a housing including one or two openings for connection to a tube. For example, the valve housing can be connected to two tube members by way of two openings, and thus be inserted, e.g. be welded into a tube. In some embodiments, tube members can already be attached (e.g. welded) to this opening or openings, which can facilitate the attachment in a tube. A fluid chamber boundary can alternatively or additionally include a connector between the valve combination, e.g. the valve seat, and a tube.

The difference between a connector and a valve housing can be, for example, that—when the valve is closed—a product, which would move in a tube along the tube (along the tube axis) that is connected to or can be connected to the valve body itself, would necessarily move through the valve housing, whereas with a connector, the product, when moving along the tube connected to the connector, could move past the connector (without necessarily being passed therethrough). In other words, a valve housing can be arranged such that a tube axis (of a tube connected to the valve housing) passes through the valve housing, whereas a connector can be disposed or be disposable such that the tube axis (of a tube connected to the connector) does not pass through the connector.

In further embodiments, for example, a first valve can be disposed in (or on) a first valve housing and a second valve (in some embodiments, via a connector) can be disposed in or on a tube.

The first valve is provided for sealing the first fluid chamber boundary against the safety chamber, and the second valve is provided for sealing the second fluid chamber boundary against the safety chamber. The safety chamber is provided between the two valves. With the actuation of the valves, the first and the second fluid chamber boundary can be connected via the safety chamber and products from the first fluid chamber boundary can then enter the second fluid chamber boundary.

The safety chamber may be surrounded by a wall which encloses it and may seal it in a fluid-tight manner. The valve seats of the first and the second valve may form part of this wall. For example, in a top view in the direction of the axis (opening direction) of the first and/or the second valve, the wall (e.g., its boundary toward the interior) can have a round e.g. (substantially) circular cross-section in the cross section through the safety chamber, perpendicular thereto.

The wall of the safety chamber can have one, two (or more) further closable openings (in addition to the valve openings) through which, for example, cleaning agent, disinfecting agent and/or steam can be introduced and discharged. In the closed state, these openings can be closed, e.g., in a fluid-tight manner (e.g., so that no product can escape from the safety chamber through these openings).

According to embodiments of the present disclosure, the valve combination in the valve seats includes means for thermal insulation of the safety chamber against the first and the second fluid chamber boundaries.

The first and the second fluid chamber boundary can but do not need to be surrounded by the valve combination.

The means for thermal insulation can include, for example, a cavity or several cavities or can be formed as such.

In some embodiments, a circumferential cavity can respectively be formed, for example, in the first and/or the second valve seat (around the valve opening), and can be arranged in the valve seat such that the circumferential cavity is disposed between the safety chamber of the first and the second fluid chamber boundary, respectively, and can thereby thermally decouple the safety chamber from the first and the second fluid chamber boundary. The term “valve seat” may include the region in which a valve is seated (in the fluid chamber boundary or in the safety chamber) and the connector element with which this region is connected to the respective counterpart to be sealed (i.e. safety chamber or fluid chamber boundary). The valve seat can be formed in one or more parts.

A valve seat can include a (metallic) first and (metallic) second side, where—in the operating state—the first side faces the safety chamber. The second side can face the fluid chamber boundary or can be in communication with the fluid chamber boundary, or face the side opposite the safety chamber. If the second side of the valve seat is connected to a part facing the fluid chamber boundary (e.g., the inner side of the fluid chamber boundary), the heat input into the product by the temperature (steam) can be reduced by thermal insulation in the safety chamber, i.e. the safety chamber can be thermally insulated from the fluid chamber boundary. In some embodiments, the heat input into the product by the temperature can be reduced responsive to the second side at least (in part) directly facing the inner side of a fluid chamber boundary, i.e. the region where a product can be present during operation.

The two sides of the valve seat may be connected to one another (at least) in the region of the valve opening and at the outer regions of the safety chamber (and in some embodiments, the outer regions of a tube enclosed by a fluid chamber boundary). The connection in thermally heavily loaded regions (i.e. in some embodiments, those regions where, by introducing steam into the safety chamber, the components, and at a certain distance therefrom, e.g. all parts which are less than 10 mm, for example, less than 5 mm away from steam, are exposed to the steam when steam is introduced into the safety chamber), in some embodiments, for example, around the valve opening, is advantageously effected by way of connector elements that are as thin as possible, e.g. have material thickness of only between 1.5 mm and 3 mm. One (or more) cavities can be arranged between the two sides of the valve seat and can be the means for thermal insulation of the safety chamber against the fluid chamber boundary.

In other embodiments, the means for thermal insulation can include several cavities, and they can be formed, for example, as cavities that are separated from each other, where the individual cavities can be arranged circumferentially along the valve seat. The cavities can there again be arranged between a first and a second side (as described above) of the valve seat. The risk of a product caking, in some embodiments, in the seat regions of a valve, can thereby be prevented.

The means for thermal insulation can be formed the same in both valve seats. In other embodiments, the means for thermal insulation in the first valve seat can be formed differently than in the second valve seat. The means for thermal insulation can be adapted, for example, to the direction of extension of a tube enclosed by the fluid chamber boundary. For example, the means for thermal insulation in the direction of extension of a tube against which the safety chamber is to be insulated by the means for thermal insulation can be arranged differently than in a direction in which the tube does not extend (e.g. wider cavities can be formed along the tube or have a larger cross-section in the direction of the valve axis of the first and/or the second valve).

According to embodiments of the present disclosure, the material thickness of the valve seat can be reduced by a cavity as compared to a solid configuration of the valve seat (e.g., reduced by the volume of the cavity). The material thickness of the first and/or the second side of the valve seat, which may be formed of metal, and, in some embodiments, the connection around the valve opening, may have a reduced thickness, for example, a reduced thickness of between 1.5 mm and 3 mm. To compensate for the respective loss of stability, a reinforcement can be applied, for example, by thicker pieces of material or by welding in reinforcements, for example, in a region of the valve combination that is less thermally loaded (for example, on the outer side of the safety chamber and the fluid chamber boundaries).

According to embodiments of the present disclosure, the cavity can be closed, e.g. be sealed in an air-tight manner. In some embodiments, the cavity is subject to a vacuum or filled with a (thermally) insulating gas or substance (“thermally insulating” material may be a material that conducts heat significantly less well than the material into which it is introduced, e.g. has a thermal conductivity at least 20% lower at a temperature of 100° C., e.g. at least 50%, e.g. at least 70% lower thermal conductivity at a temperature of 100° C.).

In other embodiments, the cavity (or cavities) can be in communication with the environment and filled with a (thermally) insulating substance. The cavity (or cavities) can be filled e.g. with a solid (thermally) insulating substance or with air. For example, it can be in communication with the environment via a leakage drain, so that—when fluid or product leaks from the safety chamber or the fluid chamber boundaries into the cavity—the escape of fluid can be detected.

In some embodiments, the cavity can be cooled by air convection or other external cooling. In some embodiments, the cavity may have ports for the supply and discharge of respective cooling agents through which, for example, air (or other cooling gases) or other coolants, for example cooling fluid, can be supplied.

The valve combination can include a body which includes or is made of the wall of the safety chamber. In some embodiments, the body of the valve combination can further include a first and/or a second fluid chamber boundary.

This body of the valve combinations can be formed integrally. In some embodiments, cavities can be introduced into the valve seats, for example, from a conventional safety chamber by cutting, chipping, and then welding them together, and the valve seats can then be reconnected (e.g., by welding) to form one part. In alternative embodiments, further parts, for example, (thermal) insulation means (e.g., insulating gas, insulating material, or vacuum) can additionally or alternatively be included in the valve seats. In other embodiments, various components can be welded together to form one part such that the body of the valve combination includes means for thermal insulation and is integrally formed.

Such single-part embodiments of the body may be advantageous with closed cavities in the valve seats, for example, cavities filled with a vacuum or insulating gas, since better leak tightness can be obtained than with the mere use of seals between components. For example, a leak in the respective cavities can therewith be prevented, or its likelihood can at least be reduced.

A single-part configuration of the wall of the safety chamber can be advantageous because components having a single-part configuration may offer less possibilities for germs to collect.

In other embodiments, the body of the valve combination can be formed having several parts. For example, a valve seat can be formed having two parts (or more than two parts), where, in some embodiments, the side facing a fluid chamber boundary can be made of a first part and the side facing the safety chamber can be made of or include a second part.

In this case, for example, the part of the valve seat facing the safety chamber can transition into the wall of the safety chamber or be connected thereto. The two parts of the valve seat can be connected e.g. by a bolt connection or other releasable connection. In some embodiments, a seal can be arranged between the two parts of the valve seat and seal the two parts against each other. Such a seal can be arranged e.g. in the region where the two parts meet in the safety chamber or in the first and/or the second fluid chamber boundary. In this case, the means for thermal insulation can include by way of example one or more seals (e.g., between two parts of a valve seat) which respectively seal against the fluid chamber boundary or the safety chamber.

In some embodiments, the seals can be arranged, such that the (metallic) parts of the valve seat, e.g. in thermally heavily loaded regions (e.g., around the valve opening), do not contact each other, but only contact via the seal, and a cavity remains between the (metallic) parts. The (metallic) parts can contact e.g. only in thermally less loaded regions, for example, at the outer region of the wall of the safety chamber and/or the fluid chamber boundary. “At the outside on the safety chamber” refers to the side of the wall of the safety chamber facing the outer side, whereas “at the inside in the safety chamber” refers to the region of the safety chamber between the valves. The same applies mutatis mutandis to the fluid chamber boundaries where “inside” describes the side of the fluid chamber boundary in which a product can be transported or stored whereas “outside” describes the side facing away from the product, where “outside on the fluid chamber boundary” can also include components connected to the fluid chamber boundary and attached to the fluid chamber boundary.

In some embodiments, the distance between the metal parts in different regions (between the sides of the valve seat) can differ in such embodiments: For example, the cavity (distance) between two parts of the valve seat can be smaller in the region immediately adjacent to the seal (to keep the seal tight), e.g. be at most 50% thereof, than in other regions, e.g. somewhat further away from the valve opening, before the parts can then meet in a third (less thermally loaded) region (in some embodiments, via a further (thermally insulating) material). For example, the parts can be bolted together.

According to embodiments of the present disclosure, the safety chamber can include two openings for the supply and discharge of cleaning agent or disinfecting agent (such as steam) (in addition to the openings of the first and the second valve). For example, these openings can be arranged such that (in the operating state where the valve combination connects a first and a second fluid chamber boundary, but in some embodiments, the first and the second valve may be closed) cleaning or disinfecting agent can be supplied through an opening from above or diagonally above and the cleaning or disinfecting agent can again drain e.g. downwardly or diagonally downwardly through another opening. The openings can therefore run completely empty and residues of the cleaning agent or condensate residue cannot collect therein.

In some embodiments, these openings can be configured for the supply and discharge of steam or condensate. The openings are each closable, so that, when the two tubes are to be connected by the first and the second valve, the connection of the first to the second tube can be established through the safety chamber without fluids or other contents of the tubes being able to escape from the safety chamber. In some embodiments, the openings can have ports, e.g. for hoses, tubes or the like.

According to embodiments of the present disclosure, the safety chamber can include, at a first and a second opening of the safety chamber, a first and a second cleaning valve which are suitable for opening and closing the openings for supplying cleaning agent or disinfecting agent (e.g., for opening when cleaning or disinfecting agent is to be passed through and for closing when the fluid chamber boundaries are to be connected via the first and the second valve).

The two cleaning valves can be disposed, for example, on two opposite sides of the safety chamber (for example, with respect to the valve axes of the first and/or the second valve), such that cleaning fluid or disinfecting agent entering from the first cleaning valve flushes the safety chamber and then drains off.

In some embodiments, openings or cleaning valves can be disposed on the safety chamber perpendicular to the valve axes of the first and/or the second valve, such that steam can be passed horizontally through the safety chamber when the valves are disposed vertically to connect fluid chamber boundaries disposed one above the other. Also in this embodiment, the two openings or cleaning valves can be arranged on two opposite sides with respect to the safety chamber.

According to embodiments of the present disclosure, the valve combination can furthermore include means for thermal insulation of the first and/or the second cleaning valve against the first and/or the second fluid chamber boundary. In some embodiments, the first cleaning valve can be thermally insulated by means for thermal insulation, for example, a cavity or a groove, against the first and/or the second fluid chamber boundary, in some embodiments in the region of the valve seat of the first and/or the second cleaning valve.

For example, the material thickness of the wall of the safety chamber around the opening of the safety chamber, which serves as a valve seat for a first cleaning valve, can be less than in other regions of the safety chamber (e.g., in the direction of the first or the second fluid chamber boundary), so that the heat flow in the direction of the first and/or the second fluid chamber boundary is reduced. If the cleaning agent has a high temperature (e.g., is steam), then the highest temperature may be reached in the region where the first cleaning valve can introduce cleaning agent or disinfecting agent (e.g., steam) into the safety chamber.

In some embodiments, the second cleaning valve can also be thermally insulated against the first or the second fluid chamber boundary, in some embodiments thermally insulated by cavities, grooves or the like, so that heat conduction in the direction of the first and/or the second fluid chamber boundary is reduced.

According to embodiments of the present disclosure, the valve combinations can be included in a double-seat and/or a double-seal valve. The present disclosure includes, in some embodiments, a double-seat and/or a double-seal valve including a valve combination as described above. The double-seat and/or the double-seal valve can include, in some embodiments, two disk valves as the first and the second valve which can be individually actuatable and have a common opening direction and can be opened along a common axis. The two disks can sit on the valve seats with seated seals.

A valve combination can include the following additional features in some embodiments, but not only, in a double-seat and/or double-seal valve.

In some embodiments, valve actuators provided in the safety chamber or in a fluid chamber boundary can be sealed in a fluid-tight manner by a bellows (e.g., a bellows made of metal) or a membrane against the safety chamber or the tube or housing, respectively. In some embodiments the valve actuators of the first and the second closure members can be sealed by a bellows or a membrane. A first cleaning valve can be arranged such that cleaning fluid exiting therefrom does not act directly upon the bellows but rather upon the safety chamber or the first or the second valve, e.g. a first or a second valve disk.

Embodiments of the present disclosure further include a machine for filling containers including one or more valve combinations, for example in one or more double-seat and/or double-seal valves, but not necessarily only in such as previously described.

Embodiments of the present disclosure further include a device in the food and beverage treatment sector, such as a filling line and/or a tank storage, in some embodiments, for example, in an aseptic region, which includes one or more valve combinations. It can include in some embodiments one or more double-seat and/or double-seal valves as previously described.

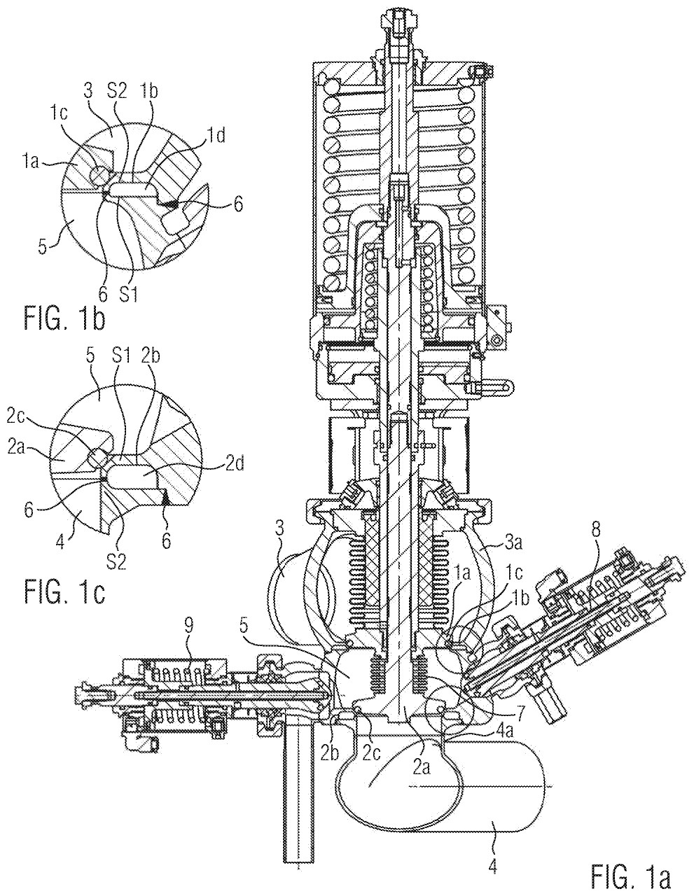

FIG. 1a shows a valve combination according to embodiments of the present disclosure in a double-seat and/or double-seal valve. The valve combination includes a first valve with a closure member 1a (e.g., by way of example a valve disk) and valve seat 1b, and a second valve with closure member 2a (e.g., by way of example a valve disk) and valve seat 2b. The valve combination is configured to connect a first fluid chamber boundary (3, 3a) to a second fluid chamber boundary (4, 4a) via a safety chamber 5. In the embodiment shown, the first fluid chamber boundary includes a valve housing 3a which may be connected to a tube or tube member 3 and in which the closure member of first valve 1a, 1b is arranged. Second valve 2a, 2b is directly connected, for example, via a connector 4a (e.g., shaped as a cylindrical wall) to tube 4 (or the tube wall), where the second fluid chamber boundary includes a tube 4 and connector 4a.

In other embodiments, each fluid chamber boundary can include a tube, and e.g. both the first tube and the second tube can be connected to the safety chamber via a valve housing, only the second valve can be connected to the second tube via a valve housing (and the first directly to the tube) or both valves can be directly connected to a tube (in some embodiments, via a connector).

In the example shown, the first valve opens in the direction of valve housing 3a, and the second valve into safety chamber 5. However, this is just one of several possible arrangements of the valves. In other embodiments, the valves can open differently, e.g. both into the safety chamber, or into the first and the second fluid chamber boundary.

In some embodiments, attached to valve disks 1a and 1b are seals 1c and 2c which are adapted to seal the valve disk against the valve seat. In other embodiments, the seal between the valve seat and the closure member can be of a different configuration or absent.

In the example shown, the two valves of the two closure members 1a and 2a by way of example have the same opening direction, the two valves therefore both open (in the image) upwardly. In some embodiments, the two valves may be actuatable independently. In other embodiments, the two valves can be opened in other directions. In some embodiments, the valve combination can also consist of two individual independently controlled main valves and laterally arranged cleaning valves (block and bleed arrangement).

According to embodiments of the present disclosure, safety chamber 5 and the fluid chamber boundaries (e.g., in some embodiments housing 3a and connector 4a) are thermally insulated from one another by means for thermal insulation in the valve seats. In some embodiments, cavities are provided by way of example in valve seat 1b, 2b as a means for thermal insulation of safety chamber 5 against the fluid chamber boundaries.

Enlarged sections of the cross section through the valve combination are shown in FIG. 1a and FIG. 1b. FIG. 1a shows, in some embodiments, a part of valve disk 1a, a cross section through seal 1c between valve disk 1a and valve seat 1b, as well as cavity 1d which may represent the means for insulating the safety chamber against fluid chamber boundary 3a.

FIG. 1c shows a comparable detail from the cross section through the second valve with valve disk 2a, valve seal 2c, valve seat 2b and cavity 2d which again thermally insulates safety chamber 5 against fluid chamber boundary 4a (and 4).

The use of weld seams 6, as drawn in, has the advantage that cavities 1d, 2d can be sealed in an airtight manner. In some embodiments, they can be filled, for example, with a vacuum or insulating gas.

In other embodiments, these cavities are not sealed in an airtight manner and have openings to the exterior.

Especially when the valve combination is arranged in a double-seat and/or double-seal valve, the valve combinations in the safety chamber can include a bellows 7 (or a membrane), as shown in FIG. 1, which separates any possibly existing valve actuators in the safety chamber from the interior of the safety chamber. If valve actuators are included through a fluid chamber boundary, then they can likewise be separated from the interior of the fluid chamber boundary by a bellows or a membrane.

The embodiment shown in FIG. 1a by way of example may further include further features (the features described below may or may not be included in other embodiments of the present disclosure or may only be partially included in other embodiments of the present disclosure). For example, the embodiment shown in FIG. 1a includes a further first cleaning valve 8 and a second cleaning valve 9. In other embodiments, other openings and/or more or fewer openings and/or cleaning valves can be included instead of the cleaning valves.

In some embodiments, the two cleaning valves 8, 9 can be arranged on a corresponding opposite side of the safety chamber with respect to the first or second valve (or the opening direction of the first and/or the second valve), so that cleaning agent from first cleaning valve 8 flushes safety chamber 5 and cleans it and can then be discharged through cleaning valves 9. Cleaning valves 8 and 9 may be operable independently of the first and the second valve.

It can be advantageous, in some embodiments, if first and the second valve 1a, 1b, and 2a, 2b can be closed while the cleaning valves are open or opened and vice versa. Cleaning of safety chamber 5 then takes place while products in fluid chamber boundary 3, 3a and 4, 4a are not contaminated by the cleaning agent (and are also thermally less impaired in the valve seats than in conventional systems due to the means for thermal insulation, e.g., cavities). In some embodiments steam can be used as a cleaning and disinfecting agent and the safety chamber can be left subjected to steam during the entire operating period in which fluid chamber boundaries 3, 3a, 4 are not connected, without this having any negative effect on the products in fluid chamber boundaries 3, 3a, 4, 4a (or where at least the time until the products cake due to the thermal load is extended, especially in the seat regions).

In other embodiments, a different number or a different arrangement of cleaning valves can be present and/or the first and the second valve can be arranged differently. Means for insulation 1d and 2d, which may be formed as cavities, can be arranged, in some embodiments, circumferentially along the entire valve seat. In other embodiments, they can be introduced in sections into the valve seat. In some embodiments, the means for thermal insulation, in some embodiments cavities, can be, for example, reinforced, enlarged or arranged in other embodiments only in regions where the valve seat extends directly along a tube (enclosed by the fluid chamber boundary), in some embodiments where a side of the valve seat forms part of the wall of a tube.

The valve seats include a side S1 facing the safety chamber and a side S2 facing away from the safety chamber. The two sides may be connected to each other at the valve opening of the first or the second valve, respectively, in FIG. 1b, 1c by a weld 6. In other embodiments, they can be connected by other connecting measures, e.g. a seal.

The thickness of the partition wall of a valve seat 1b, 2b on side S1 facing safety chamber 5 (e.g., in thermally loaded regions) can have a small thickness that is in the vicinity of the valve opening, for example, of about 2 mm, for example between 1.5 and 3 mm. On the side of the valve seat facing fluid chamber boundary 3a, 4, the material thickness is not so critical (it can be, for example, between 1.5 mm and 3 mm or more than 3 mm). It only has to allow a sufficiently large cavity 1d, 2d to be arranged between the two sides. A cavity can have a thickness or a diameter, respectively, (e.g. measured along the direction of the valve opening direction (valve axis) of the first and/or the second valve in cross section therethrough) of approx. 2-5 mm or more.

The material thickness that is necessary for stabilizing the valve combinations can be effected by the valve combination in some embodiments in the outer region, i.e. on the outer side of the safety chamber and the regions disposed on the outside of the regions disposed at the fluid chamber boundary. As can be seen by way of example in FIGS. 1b, 1c, greater material thickness is present by way of example in the outer region of the housing (body) of the valve combination, which at the same time can also provide the necessary stability.

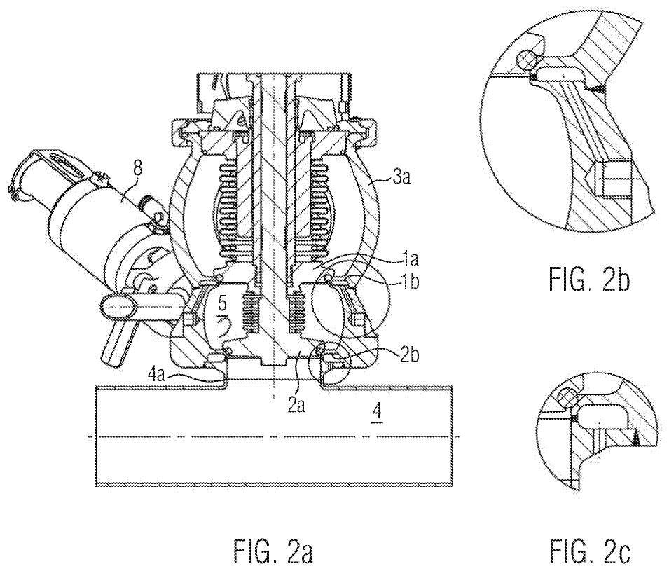

FIG. 2 shows a cross section through a valve combination, where the valve combination can optionally be similar to or the same as the valve combination in FIG. 1a, or can be a different valve combination.

Cleaning valves 8, safety chamber 5 and first valve 1a, 1b, second valve 2a, 2b as well as fluid chamber boundary 4 are drawn in schematically in FIG. 2. Sections thereof are enlarged in FIGS. 2b and 2c. As can be seen in FIGS. 2b and 2c, means for thermal insulation (e.g., the cavity) can be included in the first valve seat, as well as means for thermal insulation in the second valve seat. The cavities can include openings (e.g., bores) leading from the cavities to the exterior. The openings can be configured, in some embodiments, such that they extend downwardly in the state in which the valve combination is installed in order to connect a first and a second fluid chamber boundary, so that fluid can drain.

This allows, for example, for leak detection, for instance, when the valve seat is no longer working properly and fluid ingresses from a fluid chamber boundary and/or safety chamber into the cavity.

In other embodiments, one or more features may be different than as shown in FIGS. 2b and 2c. For example, the state in which the valve combination connects two fluid chamber boundaries, horizontally or upwardly, may be different than as shown in FIGS. 2b and 2c.

Coolant, for example, cooling fluid or the like, can be supplied through such openings and ports optionally present (not shown here). When fluid is supplied, it may be supplied through an inlet, and a further drain exists through which the coolant, for example the fluid, can then again be extracted or drained. In some embodiments, if coolant is to be supplied through an opening (with an optional port) and discharged through an opening (with an optional port), these openings (with optional ports) can be arranged such that one opening extends upwardly (or diagonally upwardly) in the operating state and one opening downwardly (or diagonally downwardly).

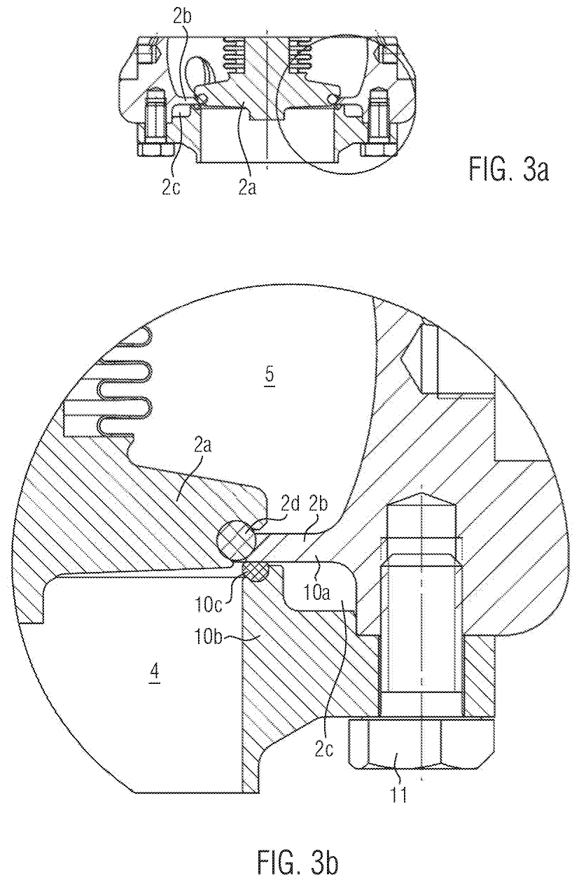

FIG. 3 shows a further cross section through a valve combination, where FIG. 3a shows parts of the valve combination and FIG. 3b shows enlarged parts of the valve combination. In the examples shown in FIG. 3a, only a section of a valve is shown, this can be the first or the second valve of a valve combination. In the example illustrated, however, the denotations and reference numerals of the second valve are respectively used for reasons of clarity of the drawings. However, this is not restrictive, this can also be a first valve. (In the arrangement as shown in FIGS. 1 and 2, the fluid chamber boundary and the safety chamber for the first valve would be applied reversed as compared to the present denotation).

FIG. 3a shows a multi-part body of a valve combination. In some embodiments, valve seat is there in two parts, where the two parts of the valve seat are referred to as 10a and 10b, which can optionally be sealed against the safety chamber by seal 10c. Seal 10c can be formed, for example, as a ring seal in a groove or in another manner.

Disposed between the two parts of valve seat 10a and 10b are means for thermal insulation of safety chamber 5 against the tube in the form of cavity 2c. The two parts 10a and 10b (the valve seat in other embodiments can include more than two parts) of the valve combinations can be connected to each other, for example, by bolts 11 or other releasable devices. In the regions where the two parts 10a and 10b are joined together, means for thermal insulation can optionally be disposed between the two parts 10a, 10b, e.g. a thermally insulating layer.

As shown, cavity 2c can have different cross sections in different regions. Specifically in the vicinity of the seal (in the region immediately adjacent to the seal, e.g., around the valve opening), the cavity can be formed having a small diameter (thickness) in the direction of the valve opening (of the first and/or the second valve), so that the seal can be effectively secured (since the seal is firmly clamped between the two parts). Advantageously, however, a cavity of a larger cross-section (thickness) between the body parts of housing 10a and 10b (cross section measured in the direction of the valve opening direction) is located somewhat farther from the seal, since thermal insulation is more effective with a larger cross-section.

When viewing a cross section through the safety chamber along the axis (through the center of the valve opening along the opening direction) of the first and/or the second valve, the measuring direction of the thickness (of the cross section) of a cavity can be, in some embodiments, a measurement along the selected (respective) axis. In one exemplary embodiment, the wall of the safety chamber can be substantially round, e.g. have a substantially circular diameter on the inner side when viewed in cross-section perpendicular to the opening direction of the first and/or the second valve.

In regions further outwardly, i.e. farther from the axis of the first and/or the second valve, the cavity can then have a larger diameter or width in cross section, e.g. at least 200% of the diameter or width in the region inside.

In the following description, a cross section through an axis of a valve (opening direction) is taken as the basis for the description.

For example, the cavity can have a thickness/cross section of between 0.5 and 1.5 mm up to a certain distance from the valve opening of the valve (the distance from the valve opening may be measured perpendicular to the axis of the valve, in some embodiments to the respective nearest edge of the valve opening). The cavity may have this thickness e.g. over a (circular) region starting at the seal to a distance of between 3 mm and 20 mm from the outer edge of the valve opening (or between 0.2 and 1.5 times the width of the seal from the seal edge).

A region can adjoin there in which cavity 2c has a greater thickness/cross section, e.g. a thickness of between 3 mm and 20 mm, e.g. over a region adjoining the region with the thickness/cross section of between 0.5 and 1.5 mm, and from there runs perpendicular (radially) outwardly. The region can extend, for example, along a width of between 5 mm and 100 mm (or between 0.1 and 0.5 times the diameter of the safety chamber in the horizontal direction and/or of the tube diameter). A thermally less loaded region can already be reached at the edge of this region.

Parts 10a and 10b of the body can then be in direct or indirect contact (for example via insulation means) in the thermally less loaded outer regions of the valve body, in this case radially outside of connector 4a and safety chamber 5, and fastened to each other, for example, with bolts 9. For example, the thermally less loaded region can include a region or be formed as a region where each point is more than 5 mm, e.g. more than 10 mm away from the inner wall of safety chamber 5.

The multi-part body of the valve combination shown in FIGS. 3a and 3b can also be employed (not shown) in the valve combinations shown in FIGS. 1a-1c and 2a-2c.

It is to be understood that the above description is intended to be illustrative, and not restrictive. Many other embodiments will be apparent upon reading and understanding the above description. Although embodiments of the present disclosure have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A valve combination for connecting a first fluid chamber boundary to a second fluid chamber boundary via a safety chamber, the valve combination comprising:
a first valve having a first valve seat and a first closure member; and
a second valve having a second valve seat and a second closure member, wherein the first valve is configured to seal the first fluid chamber boundary against the safety chamber and the second valve is configured to seal the second fluid chamber boundary against the safety chamber, wherein the valve combination is configured to provide, via the first valve seat and the second valve seat, thermal insulation of the safety chamber against the first fluid chamber boundary and the second fluid chamber boundary.

2. The valve combination of claim 1, wherein the first valve seat forms a cavity to provide the thermal insulation.

3. The valve combination of claim 2, wherein the cavity is closed and is: subject to vacuum, filled with an insulating gas, or filled with a substance.

4. The valve combination of claim 2, wherein the cavity is in communication with environment and is filled with an insulating substance.

5. The valve combination of claim 2, wherein the cavity is in communication with environment and is cooled by air convection or other external cooling.

6. The valve combination of claim 1, wherein the valve combination comprises a body that comprises or is made of a wall of the safety chamber, and wherein the body of the valve combination is formed as one part.

7. The valve combination of claim 6, wherein the body of the valve combination is formed as several parts.

8. The valve combination of claim 1, wherein the valve combination is configured to further provide the thermal insulation via one or more seals.

9. The valve combination of claim 1, wherein the safety chamber comprises two openings or ports for supply of a cleaning agent or a disinfecting agent.

10. The valve combination of claim 1, wherein the safety chamber comprises a first cleaning valve and a second cleaning valve.

11. The valve combination of claim 10, wherein the valve combination is to further provide second thermal insulation of one or more of the first cleaning valve or the second cleaning valve.

12. The valve combination of claim 1, wherein actuators of one or more of the first valve or the second valve are sealed by a bellows or a membrane.

13. The valve combination of claim 1, wherein the valve combination is one or more of a double-seat or a double-seal valve.

14. A machine for filling containers, wherein the machine comprises a valve combination for connecting a first fluid chamber boundary to a second fluid chamber boundary via a safety chamber, the valve combination comprising:
a first valve having a first valve seat and a first closure member; and
a second valve having a second valve seat and a second closure member, wherein the first valve is configured to seal the first fluid chamber boundary against the safety chamber and the second valve is configured to seal the second fluid chamber boundary against the safety chamber, wherein the first valve seat and the second valve seat are configured to provide thermal insulation of the safety chamber against the first fluid chamber boundary and the second fluid chamber boundary.

15. A device for a food and beverage treatment sector, wherein the device comprises a valve combination for connecting a first fluid chamber boundary to a second fluid chamber boundary via a safety chamber, the valve combination comprising:
a first valve having a first valve seat and a first closure member; and
a second valve having a second valve seat and a second closure member, wherein the first valve is configured to seal the first fluid chamber boundary against the safety chamber and the second valve is configured to seal the second fluid chamber boundary against the safety chamber, wherein the first valve seat and the second valve seat are configured to provide thermal insulation of the safety chamber against the first fluid chamber boundary and the second fluid chamber boundary.

16. The device of claim 15, wherein the device is a filling line.

17. The device of claim 15, wherein the device is a tank storage in an aseptic sector.

18. The device of claim 15, wherein:
the first valve seat forms a cavity to provide the thermal insulation; and
the cavity is closed and is: subject to vacuum, filled with an insulating gas, or filled with a substance.

19. The machine of claim 14, wherein:
the first valve seat forms a cavity to provide the thermal insulation; and
the cavity is in communication with environment and is filled with an insulating substance.

20. The machine of claim 14, wherein:
the first valve seat forms a cavity to provide the thermal insulation; and
the cavity is in communication with environment and is cooled by air convection or other external cooling.
